(19) United States
(12) Patent Application Publication
(10) Pub. No.: US 2011/0026707 A1
(43) Pub. Date: Feb. 3, 2011

(54) COMMUNICATION APPARATUS

(76) Inventor: Hideyuki Hatakeyama, Iwaki (JP)

Correspondence Address: ALPINE/BHGL, P.O. Box 10395, Chicago, IL, 60610, US

(21) Appl. No.: 12/730,045

(22) Filed: Mar. 23, 2010

(30) Foreign Application Priority Data
Jul. 29, 2009 (JP) 2009-176406

(51) Int. Cl. H04L 9/18; G06F 3/00

(52) U.S. Cl. 380/42; 710/58; 380/200

(57) ABSTRACT

A communication apparatus includes a plurality of isochronous transfer processing units, each of which is configured to perform isochronous transfer using an isochronous channel set thereto; a security ensuring processing unit coupled to each of the plurality of isochronous transfer processing units, and configured to perform security ensuring processing to ensure the security of isochronous transfer performed by the corresponding isochronous transfer processing unit; and a security ensuring control unit configured to, in response to a request from a second communication apparatus for ensuring security of isochronous transfer, cause the security ensuring processing unit corresponding to the isochronous transfer processing unit which performs the isochronous transfer using an isochronous channel having been notified from the second communication apparatus along with or in advance of the request for ensuring security of isochronous transfer to perform the security ensuring processing.

### RELATED APPLICATIONS

The present application claims priority to Japanese Patent Application Serial Number 2009-176406, filed Jul. 29, 2009, the entirety of which is hereby incorporated by reference.

### BACKGROUND OF THE INVENTION

1. Field of the Invention

The present invention relates to technologies that enable the ability to ensure the security of communication channels.

2. Description of the Related Art

According to the IEEE 1394 standard, a communication protocol is defined that includes three layers. The first layer is a physical layer in which signals are input and output from/to a bus, the second layer is a data link layer in which isochronous transfers and asynchronous transfers are performed using the physical layer, and the third layer is a transaction layer in which data transfers in upper layers are performed using the asynchronous transfer performed in the data link layer.

Technologies that ensure the security of isochronous transfers are defined in the communication protocol according to the IEEE 1394 standard. Technologies according to DTCP, having been developed by the Digital Transmission Licensing Administrator (DTLA), that enable the transmission and receipt of encrypted data between a source, which is a device located at a data output side, and a sink, which is a device located at a data input side, are known to those skilled in the art (refer to Japanese Unexamined Patent Application Publication No. 2005-175709, Japanese Unexamined Patent Application Publication No. 2007-312328 and Japanese Unexamined Patent Application Publication No. 2005-117174).

Technologies according to DTCP are capable of ensuring the security of communications using isochronous transfer between a source and a sink. However, there are disadvantages in that, in the case where a plurality of isochronous channels, each allowing communication using isochronous transfer thereover, are set between a source and a sink, it is impossible to independently ensure the security of communications using isochronous transfer for each of a plurality of isochronous channels. That is, it is impossible to ensure the security of communications using isochronous transfer for partially selected isochronous channels, and further, it is impossible to ensure the security of communications using isochronous transfer for isochronous channels which are each provided with a unique encryption key.

### SUMMARY OF THE INVENTION

Accordingly, it is an object of the present invention to provide a communication apparatus capable of ensuring the security of isochronous channels independently of other isochronous channels.

In order to achieve this object, a communication apparatus may include a plurality of isochronous transfer processing units, each of which is configured to perform isochronous transfer using an isochronous channel set thereto. The communication apparatus additionally includes a plurality of security ensuring processing units, each security ensuring processing unit coupled with an isochronous transfer processing unit of the plurality of isochronous transfer processing units. The security ensuring processing unit performs security ensuring processing for ensuring the security of an isochronous transfer performed by an isochronous transfer processing unit. The communication apparatus additionally includes a security ensuring control unit configured to, in response to a request from a second communication apparatus for ensuring the security of an isochronous transfer, cause the security ensuring processing unit corresponding to the isochronous transfer processing unit which performs the isochronous transfer using an isochronous channel having been notified from the second communication apparatus along with or in advance of the request for ensuring security of isochronous transfer, to perform the security ensuring processing.

Further, in order to achieve the object, a communication apparatus may include a plurality of isochronous transfer processing units, each of which is configured to perform isochronous transfer using an isochronous channel set thereto. The communication apparatus additionally includes a plurality of security ensuring processing units, each security ensuring processing unit coupled with an isochronous transfer processing unit of the plurality of isochronous transfer processing units. The security ensuring processing unit performs security ensuring processing for ensuring the security of an isochronous transfer performed by an isochronous transfer processing unit. The communication apparatus additionally includes a security ensuring control unit configured to, in response to a request from a second communication apparatus for ensuring the security of an isochronous transfer, cause the security ensuring processing unit corresponding to the isochronous transfer processing unit which performs the isochronous transfer using an isochronous channel having been immediately previously set between the second communication apparatus and the communication apparatus, to perform the security ensuring processing.

In some implementations, a communication apparatus may include a communication chip configured to incorporate therein a physical layer and a data link layer both conforming to the IEEE 1394 standard. The communication chip may further include a plurality of isochronous transfer pre-processing units. Each isochronous transfer pre-processing unit is configured to convert a piece of data into an isochronous packet and relay the isochronous packet to the data link layer. The piece of data is included in a data stream supplied to the ischochronous transfer pre-processing unit and is isochronously transferred using an isochronous channel. The communication chip may additionally include a plurality of DTCP processing units, each DTCP processing unit coupled with an isochronous transfer pre-processing unit of the plurality of isochronous transfer pre-processing units. The partial DTCP processing unit is configured to perform encryption of a piece of data included in a data stream, which is converted into an isochronous packet by the corresponding isochronous transfer pre-processing unit. The partial DTCP processing unit performs the encryption in accordance with the DTCP standard having been developed by the Digital Transmission Licensing Administrator (DTLA). The partial DTCP processing unit is configured to partially perform a procedure of setting an encryption key and a decryption key used for the encryption, the procedure conforming to the DTCP standard. The communication apparatus may additionally include a DTCP procedure execution unit configured to, in response to a request from a second communication apparatus for authentication conforming to the DTCP standard, execute a procedure to set an encryption key and a decryption key used for the decryption using the partial DTCP processing unit corresponding to the isochronous transfer pre-processing unit provided with an isochronous channel having been notified from the second communication apparatus along with or in advance of the request for authentication, thereby enabling the communication apparatus to ensure the security of isochronous channels independent of other isochronous channels.

In other implementations, a communication apparatus may include a PCR/CMP layer conforming to the IEC 61883 standard, which is configured to establish an isochronous channel with a second communication apparatus, and set the established isochronous channel to one of the plurality of isochronous transfer pre-processing units, to which a data stream including a piece of data to be isochronously transferred by using the established isochronous channel is inputted. The communication apparatus may additionally include a DTCP procedure execution unit configured to, in response to a request from a second communication apparatus for authentication conforming to the DTCP standard, execute a procedure for setting an encryption key and a decryption key used for the encryption using the partial function of the partial DTCP processing unit corresponding to the isochronous transfer pre-processing unit provided with an isochronous channel having been immediately previously established with the different communication apparatus, thereby enabling the communication apparatus to ensure the security of isochronous channels independent of the other isochronous channels.

As described above, according to aspects of the present invention, it is possible to provide a communication apparatus capable of ensuring the security of isochronous channels independent of other isochronous channels.

### BRIEF DESCRIPTION OF THE DRAWINGS

FIG. 1 is a block diagram illustrating a configuration of an AV system;

FIG. 2 is a block diagram illustrating a configuration of functions included in an AV apparatus;

FIG. 3A is a flowchart illustrating DTCP processing at a sink side; and

FIG. 3B is a flowchart illustrating DTCP processing at a source side.

### DESCRIPTION OF THE PREFERRED EMBODIMENTS

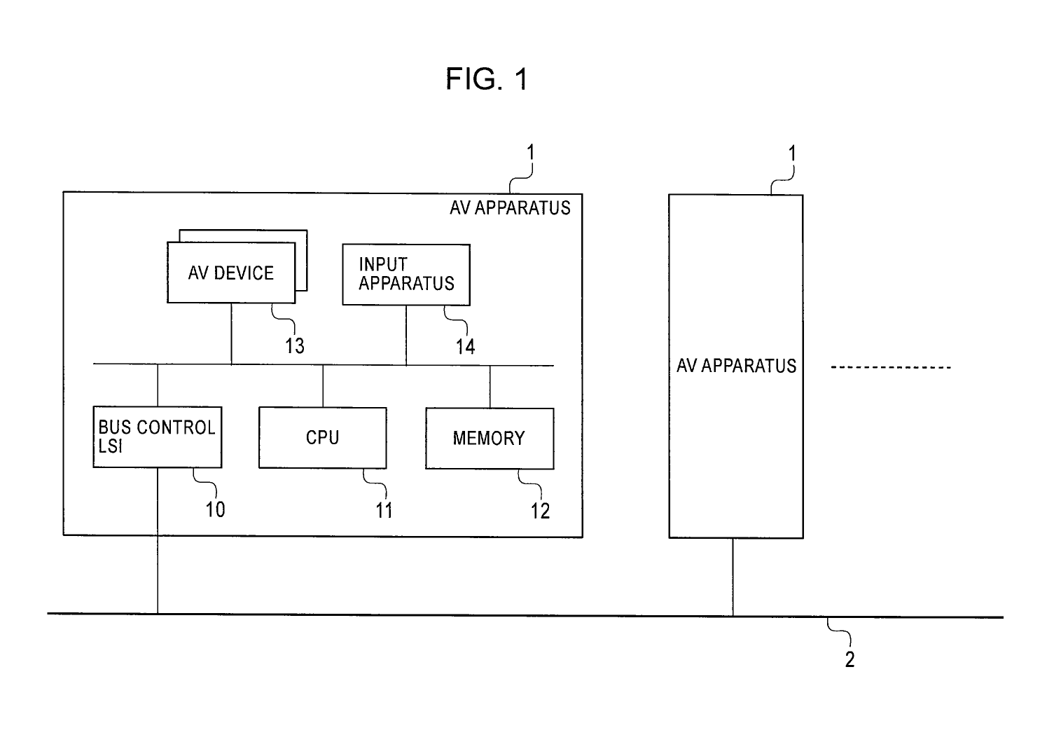

FIG. 1 is a diagram illustrating a configuration of an AV system. As shown in FIG. 1, the AV system is a system configured to include a plurality of AV apparatuses 1, each being connected to a bus 2 conforming to the IEEE 1394 standard. The AV apparatuses 1 are each configured to include a bus control LSI 10, a CPU 11, chips of memory 12, AV devices 13, an input apparatus 14 and the like. Here, the AV device 13 is a device configured to input and output at least one of a stream of audio signals and a stream of visual signals, such as a display, an audio reproduction device, a video reproduction device, a television receiver, a radio receiver and an audio output device.

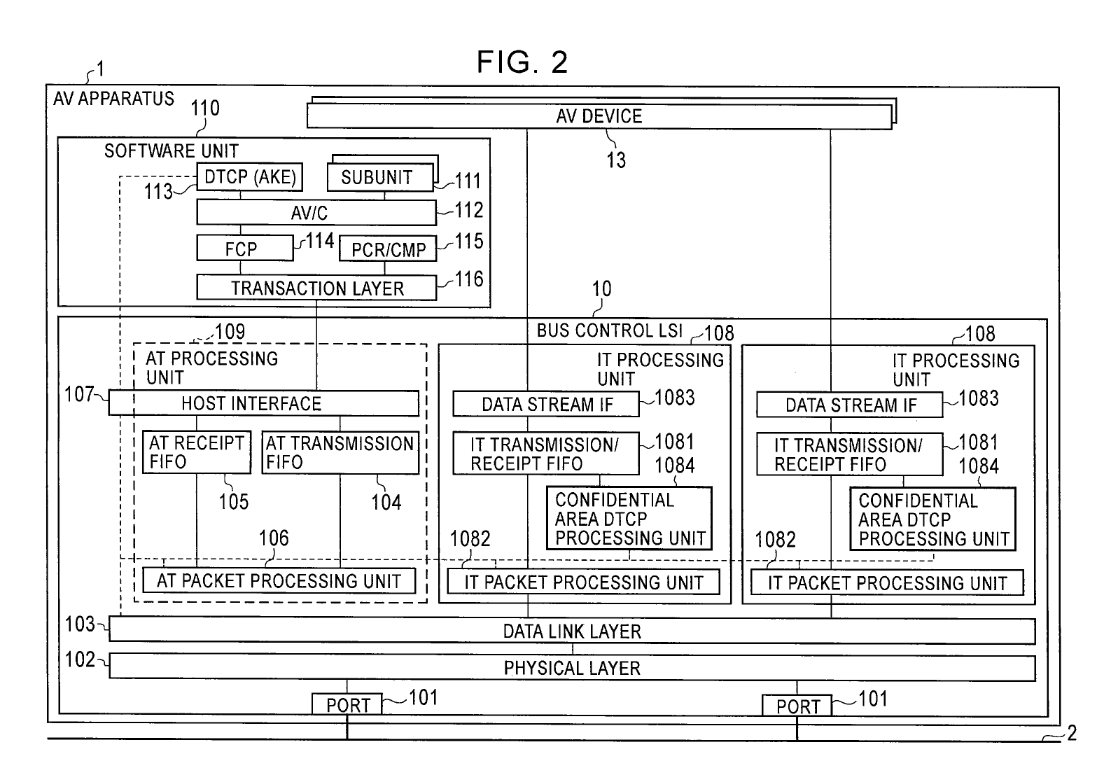

A configuration of functions included in the AV apparatus 1 is shown in FIG. 2. Here, each of the functions inside a software unit 110 shown in FIG. 2 is a function fulfilled by causing a CPU 11 to execute the corresponding program stored in the chips of memory 12.

As shown in FIG. 2, a bus control LSI 10 includes therein two ports 101 configured to be connected to the bus 2, a physical layer 102 conforming to the IEEE 1394 standard, which is configured to input and output signals from/to the bus 2 via the ports 101, and a data link layer 103 conforming to the IEEE 1394 standard, which is configured to, by using the physical layer 102, perform isochronous transfer and asynchronous transfer.

Further, the bus control LSI 10 includes therein an AT transmission FIFO 104 configured to store therein pieces of data to be transmitted by means of asynchronous transfer and an AT receipt FIFO 105 configured to store therein pieces of data having been received by means of asynchronous transfer. The bus control LSI 10 additionally includes an AT packet processing unit 106 configured to perform control of processing for inputting and outputting of data performed between the data link layer 103 and the AT receipt FIFO 105, and between the data link layer 103 and the AT transmission FIFO 104, the processing for inputting and outputting of data being performed for each of asynchronous packets. The bus control LSI 10 further includes a host interface 107 configured to perform processing for inputting and outputting of pieces of data and inputting and outputting of various kinds of control data, the processing being performed between individual function units included in the software unit 110 and the AT receipt FIFO 105 and between individual function units included in the software unit 110 and the AT transmission FIFO 104.

Here, for convenience, the AT transmission FIFO 104, the AT receipt FIFO 105, the AT packet processing unit 106 and a portion of the host interface 107, which performs inputting and outputting of data from/to the AT transmission FIFO 104 and the AT receipt FIFO 105, are integrated into a unit, which will be hereinafter called “an AT processing unit 109”.

Further, the bus control LSI 10 includes two isochronous transfer processing units (“IT processing units”) 108 therein. Each of the IT processing units 108 includes therein an IT transmission/receipt FIFO 1081 configured to store therein pieces of data to be transmitted and having been received by means of isochronous transfer. Each of the IT processing units 108 additionally includes an IT packet processing unit 1082 configured to perform data processing between the data link layer 103 and the IT transmission/receipt FIFO 1081, the data processing including a process of inputting and outputting of data performed for each of isochronous packets, which are transmitted and received to/from the data link layer by means of isochronous transfer, a process of performing control of packeting and depacketing into/from isochronous packets, and a process of performing control of transmitting and receiving of the isochronous packets. Each of the IT processing units 108 further includes a data stream interface 1083 configured to perform processing on video streams and audio streams to be outputted and having been inputted to/from the AV devices 13, and pieces of data to be outputted and having been inputted to/from the IT transmission/receipt FIFO 1081. Each of the IT processing units 108 includes a confidential area DTCP processing unit 1084 (also known as a security ensuring processing unit) configured to perform processing for encryption and decryption of pieces of data each being transferred in the form of an isochronous packet, and setting of Encryption Mode Indicator (EMI) on isochronous packets, the processing conforming to DTCP having been developed by the Digital Transmission Licensing Administrator (DTLA).

Here, the confidential area DTCP processing unit 1084 includes an authentication function configured to, in response to a request from the software unit 110 (also known as the security ensuring control unit or the DTCP procedure execution unit) via the host interface 107, create and output authentication information used for device authentication for the AV apparatus 1 itself, and validate different AV apparatuses 1 by using pieces of authentication information regarding the different AV apparatuses 1. The confidential area DTCP processing unit 1084 additionally includes a key setting function configured to, in response to a request from the software unit 110 via the host interface 107, create and output key information exchanged between AV apparatuses 1, and perform setting of encryption/decryption keys used for processing for encryption/decryption on the basis of the created and outputted key information.

The software unit 110 includes subunits 111 each configured to perform control of an AV device 13 and an AV/C layer 112 conforming to the AV/C standard having been developed by the 1394 Trade Association, which is configured to provide the subunits 111 with control interfaces with different AV apparatuses 1. The software unit 110 further includes a DTCP layer 113 configured to execute device authentication procedures and encryption key/decryption key setting procedures according to DTCP; an FCP layer 114 conforming to the IEC 61883-1 standard, which is configured to provide the AV/C layer 112 and the DTCP layer 113 with a protocol for data transmission and receipt; a PCR/CMP layer 115 conforming to the IIEC 61883 standard, which is configured to perform setting and management of isochronous channels over which isochronous transfer is performed; and a transaction layer 116 conforming to the IEEE 1394 standard.

Here, by using units configured in such a manner as described above, data steams, such as audio data streams and video data streams, are transferred by means of isochronous transfer.

Procedures of this isochronous transfer are described below. First, the PCR/CMP layer 115 of the AV apparatus 1, which is a transmitter of transfer of data streams, executes prescribed sessions with an IRM conforming to the IEEE 1394 standard, which is configured to manage resources on the bus 2. The PCR/CMP layer 115 of a different AV apparatus 1, which is a receiver of the transfer of data streams, by means of asynchronous transfer using asynchronous packets, performed via the transaction layer 116 and the AT processing unit 109 of the bus control LSI 10, establishes an isochronous channel to be used for the transfer of data streams.

In each of the AV apparatuses 1 functioning as the transmitter and the receiver of the transfer of data streams, information regarding the isochronous channel having been established in order to perform the transfer of data streams is set to the IT processing unit 108 having the data stream interface 1083, to which a pair of ports included in the AV device 13, used for inputting/outputting of data streams targeted for the transfer are connected, and then, the IT processing unit 108 is caused to transmit and receive isochronous packets using the isochronous channel which was identified from the information regarding the established isochronous channel having been set thereto.

Further, in each of the AV apparatuses 1 functioning as the transmitter and the receiver of the transfer of data streams, the DTCP layer 113 executes a prescribed session for AKE with the DTCP layer 113 at the opposing side by utilizing asynchronous transfer using asynchronous packets, performed via the AV/C layer 112, the FCP layer 114, the transaction layer 116 and the AT processing unit 109 of the bus control LSI 10. The DTCP layer 113 additionally performs DTCP processing, which will be described below. The DTCP processing causes the confidential area DTCP processing unit 1084 of the IT processing unit 108 having been provided with the isochronous channel to be used for the transfer of data streams to perform setting of an encryption/decryption key to the isochronous channel, and thereby, provide the ability to ensure the security of the isochronous channel to be used for the transfer of data streams.

Further, in each of the AV apparatuses 1, the AV device 13 is caused to commence inputting and outputting of data streams targeted for the transfer from/to the bus control LSI 10.

Processing performed in such a manner as described above results in ensuring the security of subsequently transferred data streams using the isochronous channel that has been established between the AV apparatuses 1 that are functioning as the transmitter and the receiver.

The above-described DTCP processing performed by the DTCP layer 113 will be described below. First, the DTCP layer 113 of the AV apparatus, functioning as a sink, performs DTCP processing at a receiver side of transfer of data streams, that is, DTCP processing at a sink side, which is one part of the DTCP processing.

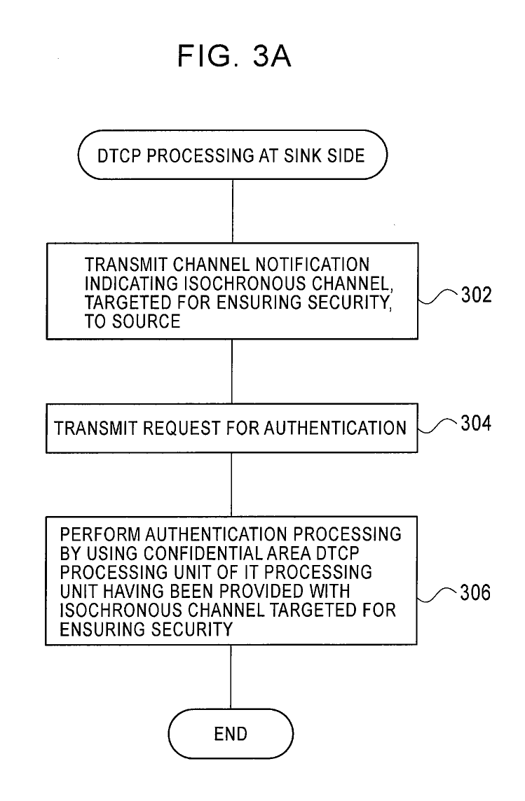

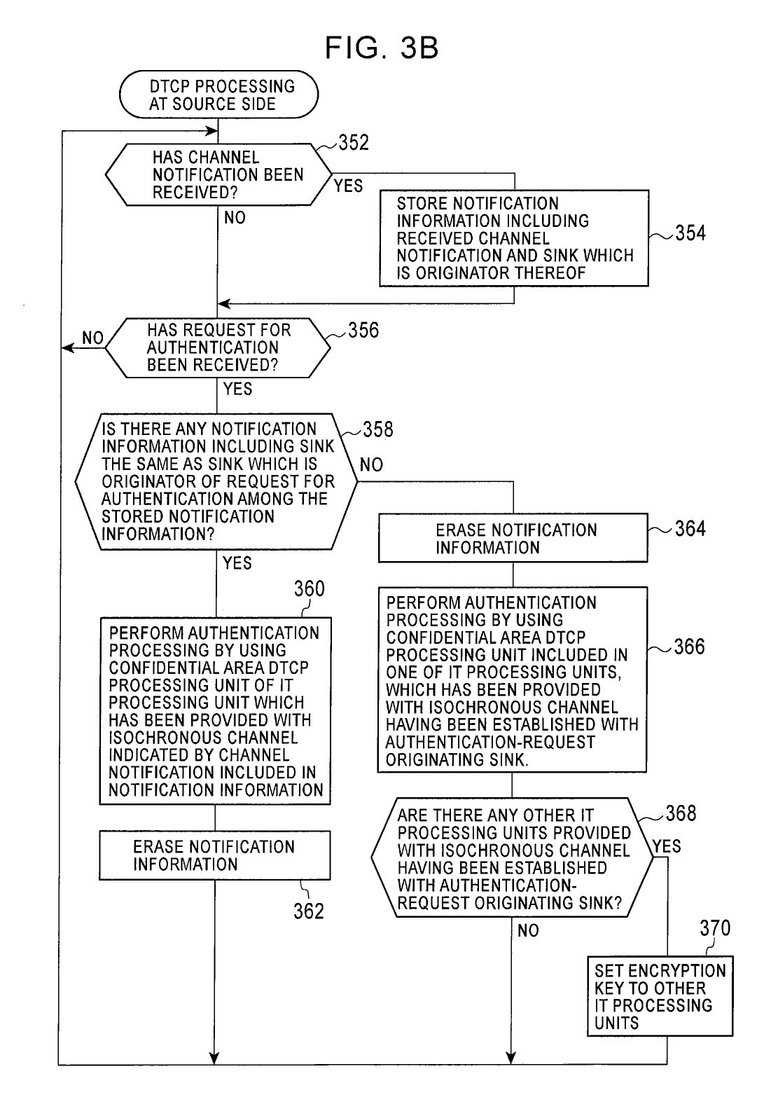

As shown in FIG. 3A, in the DTCP processing at a sink side, once an isochronous channel targeted for ensuring the security is specified by referring to the PCR/CMP layer 115, a channel notification indicating a piece of information such as the channel number of an isochronous channel targeted for ensuring security is transmitted to the DTCP layer 113 at a transmitter side of the transfer of data streams, that is, the DTCP layer 113 functioning as a source (in step 302).

Further, the DTCP layer 113 of the AV apparatus 1 functioning as a sink, transmits a request for authentication to the DTCP layer 113 of the AV apparatus 1 functioning as a source (in step 304). The DTCP layer 113 of the AV apparatus 1 functioning as a sink executes a session for AKE with the DTCP layer 113 functioning as a source, concurrently with utilization of the functions of authentication and key setting fulfilled by the confidential area DTCP processing unit 1084 of the IT processing unit 108 having been provided with the isochronous channel targeted for ensuring security (in step 306).

As a result of this processing, a decryption key for decrypting the isochronous channel targeted for ensuring security is set to the confidential area DTCP processing unit 1084 of the IT processing unit 108 functioning as a sink having been provided with the isochronous channel targeted for ensuring security. Subsequently, decryption of data which has been received in the form of an isochronous packet is performed by using the decryption key set thereto.

DTCP processing at a source side, which is the other part of the DTCP processing and is performed by the DTCP layer 113 of the AV apparatus 1 functioning as a source, will be described below. As shown in FIG. 3B, in the DTCP processing at a source side, first, upon receipt of a channel notification from the DTCP layer 113 functioning as a sink, the DTCP layer 113 functioning as a source stores therein a piece of information regarding the channel number indicated by the channel notification and a piece of identification information regarding a sink, i.e., a transmitter of the channel notification as a piece of notification information (in step 354).

Upon receipt of a request for authentication from the DTCP layer 113 at the sink side (in step 356), the DTCP processing unit 113 at the source side determines whether or not any piece of notification information is stored including the same piece of identification information as that of the sink, i.e., the transmitter of the request for authentication (step 358).

In the case where the result of the determination at step 358 is “Yes,” by referring the PCR/CMP layer 115, the DTCP processing unit 113 at the source side specifies an isochronous channel having the same channel number as the channel number indicated by the piece of notification information as an isochronous channel targeted for ensuring security. The DTCP processing unit 113 at the source executes a session for AKE with the DTCP layer 113 functioning as a sink, concurrently with utilization of the functions of authentication and key setting fulfilled by the confidential area DTCP processing unit 1084 of the IT processing unit 108, having been provided with the specified isochronous channel (in step 360).

As a result of such processing as described above, an encryption key for encrypting an isochronous channel targeted for ensuring security is set to only the confidential area DTCP processing unit 1084 of the IT processing unit 108 having been provided with an isochronous channel having the same channel number as the channel number indicated by the notification information. Subsequently, by using this encryption key, encryption of data to be transmitted in the form of an isochronous packet is performed.

The stored piece of notification information having been used for the above-described processing is erased (step 362), and then, the flow of procedure returns to step 352.

In the case where the result of the determination at step 358 is “No,” the stored piece of notification information having been used for the determination is erased. Additionally, by referring to the PCR/CMP layer 115, the DTCP processing unit 113 at the source side specifies isochronous channels having been established with the sink, i.e., the transmitter of the request for authentication. Further, the DTCP processing unit 113 at the source side executes a session for AKE with the DTCP layer 113 functioning as a sink, concurrently with utilization of the functions of authentication and key setting fulfilled by the confidential area DTCP processing unit 1084 included in one of the IT processing units 108 provided with the specified isochronous channels (in step 366). Additionally, the DTCP processing unit 113 at the source side determines whether or not there are any other IT processing units 108 provided with isochronous channels having been established with the sink, i.e., the transmitter of the request for authentication (in step 368), besides the IT processing unit 108 including the confidential area DTCP processing unit 1084 used for the session for AKE. In the case where the result of the determination is “No,” the flow of procedure returns to step 352. In the case where the result of the determination is “Yes,” the DTCP processing unit 113 at the source side causes the confidential area DTCP processing unit 1084 having been used for executing the session for AKE to set an encryption key having been created during the session for AKE to the confidential area DTCP processing units 1084 included in the IT processing units 108, the existence of which has been determined in step 368 (in step 370).

As a result of such processing as described above, an encryption key common to the isochronous channel is set to the confidential area DTCP processing unit included in each of the IT processing units, which is provided with an isochronous channel having been established with a certain sink. That is, provided that two isochronous channels are established with a certain sink, an encryption key common to these two isochronous channels is set to the two IT processing units 108, which are provided with the two isochronous channels, respectively. Subsequently, in the confidential area DTCP processing unit 1084 of each of the IT processing units 108, encryption of data to be transmitted in the form of an isochronous packet is performed by using this common encryption key.

The flow of the procedure returns to step 352. Here, in the above-described DTCP processing at a source side, in the case where it is determined that notification information including therein identification information regarding a sink i.e., a transmitter of a request for authentication is not stored (in step 358), the flow of procedure results in proceeding to the same point that to which the flow of procedure in existing DTCP processing at a source side usually proceeds when a source receives a request for authentication. Therefore, a source can properly ensure the security of isochronous transfer to/from any of sinks, each sink not having the ability to transmit a channel notification to the source.

In implementations other than those described above, an isochronous channel targeted for ensuring security is notified of the channel number using a channel notification transmitted from a sink to a source prior to a request for authentication. However, this notification of the channel number of an isochronous channel targeted for ensuring security may also be included in a request for authentication, or the notification of the channel number may be performed during commands transmitted from the sink to the source in authentication processing performed subsequent to the request for authentication.

Alternatively, the notification of the channel number from a sink to a source may be abolished, and as described below, a method may be employed in which an isochronous channel targeted for ensuring security is specified at a source side upon receipt of a request for authentication. That is, processing may be performed so that, for each of the other AV apparatuses 1, an isochronous channel having been immediately previously established with the AV apparatus 1 itself is stored in the PCR/CMP layer 115.

Further, at a source side, upon receipt of a request for authentication from a sink, an isochronous channel is specified as an isochronous channel targeted for ensuring security, the isochronous channel being stored in the PCR/CMP layer 115 and corresponding to the AV apparatus 1 functioning as the sink. In this case, in order to ensure secure communications for a plurality of isochronous channels, it is necessary for a sink to, for each of the plurality of isochronous channels targeted for ensuring security, successively perform processing for establishment of an isochronous channel and processing for authentication.

Therefore, such an embodiment as described above enables ensuring security of communication for each of isochronous channels.

It is therefore intended that the foregoing detailed description be regarded as illustrative rather than limiting, and that it be understood that it is the following claims, including all equivalents, that are intended to define the spirit and scope of this invention.

What is claimed is:

1. A communication apparatus comprising:
a plurality of isochronous transfer processing units, each isochronous transfer processing unit configured to perform isochronous transfer using an isochronous channel set thereto;
a plurality of security ensuring processing units, each security ensuring processing unit coupled with an isochronous transfer unit of the plurality of isochronous transfer processing units, each security ensuring processing unit configured to perform security ensuring processing for ensuring the security of an isochronous transfer performed by a corresponding isochronous transfer processing unit; and
a security ensuring control unit configured to, in response to a request from a second communication apparatus to ensure the security of an isochronous transfer, cause the security ensuring processing unit coupled with the isochronous transfer processing unit which performs the isochronous transfer using an isochronous channel having been notified from the different communication apparatus along with or in advance of the request for ensuring security of isochronous transfer, to perform the security ensuring processing.

2. A communication apparatus comprising:
a plurality of isochronous transfer processing unit, each isochronous transfer processing unit configured to perform isochronous transfer using an isochronous channel set thereto;
a plurality of security ensuring processing units, each security ensuring processing unit coupled with an isochronous transfer unit of the plurality of isochronous transfer processing units, each security ensuring processing unit configured to perform security ensuring processing for ensuring the security of an isochronous transfer performed by a corresponding isochronous transfer processing unit; and
a security ensuring control unit configured to, in response to a request from a second communication apparatus to ensure the security of an isochronous transfer, cause the security ensuring processing unit coupled with the isochronous transfer processing unit which performs the isochronous transfer using an isochronous channel having been immediately previously set between the different communication apparatus and the communication apparatus itself, to perform the security ensuring processing.

3. A communication apparatus including a communication chip configured to incorporate therein a physical layer and a data link layer both conforming to the IEEE 1394 standard, the communication chip comprising:
a plurality of isochronous transfer pre-processing units, each isochronous transfer pre-processing unit configured to convert a piece of data into an isochronous packet and relay the isochronous packet to the data link layer, where the piece of data is part of a data stream received at the isochronous transfer pre-processing unit that is transferred to the isochronous transfer pre-processing unit using an isochronous channel set thereto; and
a plurality of DTCP processing units, each DTCP processing unit coupled with an isochronous transfer pre-processing unit of the plurality of isochronous transfer pre-processing units, the DTCP processing unit configured to encrypt a piece of data included in a data stream that an isochronous transfer pre-processing unit has converted into an isochronous packet, the encryption being performed in accordance with a DTCP standard having been developed by the Digital Transmission Licensing Administrator (DTLA), and configured to partially perform a procedure of setting an encryption key and a decryption key used for the encryption, the procedure conforming to the DTCP standard,
a DTCP procedure execution unit configured to, in response to a request for authentication conforming to the DTCP standard, the request having been transmitted from a second communication apparatus, execute a procedure for setting an encryption key and a decryption key used for the encryption between the communication apparatus and the second communication apparatus using the DTCP processing unit corresponding to the isochronous transfer pre-processing unit provided with an isochronous channel having been notified from the different communication apparatus along with or in advance of the request for authentication.

4. A communication apparatus including a communication chip configured to incorporate therein a physical layer and a data link layer both conforming to the IEEE 1394 standard, the communication chip comprising:
a plurality of isochronous transfer pre-processing units, each isochronous transfer pre-processing unit configured to convert a piece of data into an isochronous packet and relay the isochronous packet to the data link layer, where the piece of data is part of a data stream received at the isochronous transfer pre-processing unit that is transferred to the isochronous transfer pre-processing unit using an isochronous channel set thereto; and
a plurality of DTCP processing units, each DTCP processing unit coupled with an isochronous transfer pre-processing unit of the plurality of isochronous transfer pre-processing units, the DTCP processing unit configured to encrypt a piece of data included in a data stream that an isochronous transfer pre-processing unit has converted into an isochronous packet, the encryption being performed in accordance with the DTCP standard having been developed by the Digital Transmission Licensing Administrator (DTLA), and configured to partially performing a procedure of setting an encryption key and a decryption key used for the encryption, the procedure conforming to the DTCP standard,
wherein the communication apparatus comprises:
a PCR/CMP layer conforming to the IEC 61883 standard, which is configured to establish an isochronous channel with a second communication apparatus, and set the established isochronous channel to one of the plurality of isochronous transfer pre-processing units, to which a data stream including a piece of data to be isochronously transferred by using the established isochronous channel is inputted, and
a DTCP procedure execution unit configured to, in response to a request for authentication conforming to the DTCP standard, the request having been transmitted from a second communication apparatus, execute a procedure for setting an encryption key and a decryption key used for the encryption between the communication apparatus and the second communication apparatus using the DTCP processing unit corresponding to the isochronous transfer pre-processing unit provided with an isochronous channel having been immediately previously established with the different communication apparatus.

5. An apparatus comprising:
a computer-readable non-transitory store medium comprising a computer program;
a computer comprising a processor, wherein the computer is configured to read and execute the computer program stored on the computer-readable non-transitory storage medium, the computer further comprising a communication chip incorporating therein a physical layer and a data link layer both conforming to the IEEE 1394 standard, the communication chip comprising:
a plurality of isochronous transfer pre-processing units, each isochronous transfer pre-processing unit configured to convert a piece of data into an isochronous packet and relay the isochronous packet to the data link layer, where the piece of data is part of a data stream received at the isochronous transfer pre-processing unit that is transferred to the isochronous transfer pre-processing unit using an isochronous channel set thereto; and
a plurality of DTCP processing units, each DTCP processing unit coupled with an isochronous transfer pre-processing unit of the plurality of isochronous transfer pre-processing units, the DTCP processing unit configured to encrypt a piece of data included in a data stream that an isochronous transfer pre-processing unit has converted into an isochronous packet, the encryption being performed in accordance with the DTCP standard having been developed by the Digital Transmission Licensing Administrator (DTLA), and configured to partially performing a procedure of setting an encryption key and a decryption key used for the encryption, the procedure conforming to the DTCP standard,
wherein the computer program causes the computer to function as a DTCP procedure execution unit configured to execute a DTCP procedure between a second communication apparatus and the computer, the DTCP procedure execution unit being configured to, in response to a request for authentication conforming to the DTCP standard, the request having been transmitted from the second communication apparatus, execute a procedure for setting an encryption key and a decryption key used for the encryption using the DTCP processing unit corresponding to the isochronous transfer pre-processing unit provided with an isochronous channel having been notified from the second communication apparatus along with or in advance of the request for authentication.

6. A communication apparatus comprising:
a computer-readable non-transitory storage medium comprising computer program;
a computer comprising a processor, wherein the computer is configured to read and executed the computer program stored on the computer-readable non-transitory storage medium, the computer further comprising a communication chip incorporating therein a physical layer and a data link layer both conforming to the IEEE 1394 standard, the communication chip comprising:
a plurality of isochronous transfer pre-processing units, each isochronous transfer pre-processing unit configured to convert a piece of data into an isochronous packet and relay the isochronous packet to the data link layer, wherein the piece of data is part of a data stream received at the isochronous transfer pre-processing unit that is transferred to the isochronous transfer pre-processing unit using an isochronous channel set thereto; and
a plurality of DTCP processing units, each DTCP processing unit coupled with an isochronous transfer pre-processing unit of the plurality of isochronous transfer pre-processing units, the DTCP processing unit configured to encrypt a piece of data included in a data stream that an isochronous transfer pre-processing unit has converted into an isochronous packet, the encryption being performed in accordance with the DTCP standard having been developed by the Digital Transmission Licensing Administrator (DTLA), and configured to partially perform a procedure of setting an encryption key and a decryption key used for the encryption, the procedure conforming to the DTCP standard,
wherein the computer program causes the computer to function as a PCR/CMP layer conforming to the IEC 61883 standard, and a DTCP procedure execution unit configured to execute DTCP processing between a second communication apparatus and the computer, the PCR/CMP layer being configured to establish an isochronous channel with the second communication apparatus, and set the established isochronous channel to one of the plurality of isochronous transfer pre-processing units that receives a data stream including a piece of data to be isochronously transferred using the established isochronous channel, the DTCP procedure execution unit being configured to, in response to a request from the second communication apparatus for authentication conforming to the DTCP standard, execute a procedure for setting an encryption key and a decryption key used for the encryption using DTCP processing unit corresponding to the isochronous transfer pre-processing unit provided with an isochronous channel having been immediately previously established with the different communication apparatus.
